(19) United States
(12) Patent Application Publication
(10) Pub. No.: US 2010/0089835 A1
(43) Pub. Date: Apr. 15, 2010

(54) METHOD AND EQUIPMENT FOR PROCESSING FATTY WASTE

(76) Inventors: Fabrice Lefebvre, Gouvieux (FR); Dominique Helaine, Luzarches (FR); Tristan Robino, Thiers Sur Theve (FR); Frédéric Vernhes, Luzarches (FR)

Correspondence Address: MILES & STOCKBRIDGE PC, 1751 PINNACLE DRIVE, SUITE 500, MCLEAN, VA, 22102-3833, US

(21) Appl. No.: 12/523,688

(22) PCT Filed: Jan. 8, 2008
(86) PCT No.: PCT/FR08/50026

§ 371 Date: Dec. 8, 2009

(30) Foreign Application Priority Data
Jan. 19, 2007 (FR) 0700385

(51) Int. Cl. B01D 17/02; B01D 21/00; B01D 21/01; C11B 13/00

(52) U.S. Cl. 210/710; 210/773; 210/737; 210/181; 210/173; 210/179; 210/178

(57) ABSTRACT

The invention relates particularly to an equipment for processing fatty waste (1) essentially comprising a fatty fraction (11), an aqueous fraction (12), and a residual fraction (13), wherein said equipment includes at least one boiler (2), a station (3) for collecting waste (1), a fractioning station (4), a loop including a duct (5) having a constant utility volume for the waste (1) flow between the collecting station (3) and the fractioning station (4), and at least one heat exchanger (61-63) for heating the waste. According to the invention, each heat exchanger (61-63) is mounted on said duct (5).

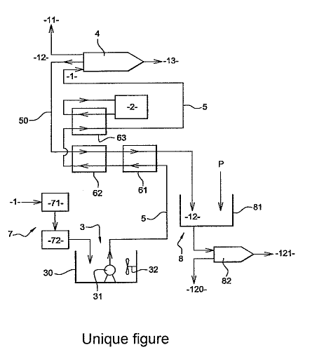

The invention generally relates to environmental friendly techniques.

More particularly, according to a first aspect, the invention relates to a method for the processing of fatty waste substantially composed of a fatty fraction, an aqueous fraction and a residual fraction, this method comprising at least heating, flowing and fractioning steps of respectively heating waste at least until the melting of the fatty fraction, of flowing the waste from a colleting station to a fractioning station into a loop including a constant working volume duct, and of separating the various fractions of waste.

Such a method, particularly intended for the processing of human or animal originating food waste, is described in detail in French patent FR 2 720 014.

As for this prior patent object, the present invention is applicable, among other things, to fatty waste outputted by agri-food industries and particularly to waste from decantation facilities, manufacturing rejections and cleaning effluent of these industries. The invention is also applicable to waste originating from restaurants and food-preparing facilities as well as to waste from urban or industrial wastewater pretreatment facilities such as skimming tanks and degreasers. Such wastes are generally collected during maintenance operations of separation, retention and storage facilities.

Fatty waste comprise pure or mixed, totally or partially hydrolyzed or unchanged, animal or vegetable fat substantially exhibiting three fractions:
a first aqueous fraction containing dissolved or suspended substances;
a second emulsified, diffused or supernatant, particulate organic fraction, composed of fat, and
a third, or residual, fraction including suspended, supernatant or sedimented organic or mineral particles (tissues, meal leftovers, vegetable deposits, papers, plastics, glass, metal objects particularly, flatware, gravels, etc.).

The respective weight-based or volume-based percentages of these various fractions depend particularly on their origin as well as, possibly, on the time of year in the case where the waste source relates to a seasonal activity.

The method and equipment described in the aforementioned prior patent, despite their interest and the tremendous services rendered, require, from an encumbrance and operating standpoints, numerous constraints that can hardly be satisfied.

In this context, the present invention aims to provide a method and equipment for the processing of fatty waste exhibiting a better compromise for the resolution of issues induced raised by their implementation.

To this end, the method of the invention, which further conforms to the generic definition given thereto by the preamble above, is substantially characterized in that the heating step is carried out by heating the wastes solely while they are flown in said constant working volume duct.

In fact, while the known method of patent FR 2 720 014 was based on the assumption that it is required to heat at least partially the fatty waste within a variable working volume buffer tank, the invention is based on the finding that the processing of these wastes may be done without such temporary storage.

Preferably, the heating step is partially carried out by reheating the fatty waste to be processed by means of the aqueous fraction originating from fatty waste fractioned beforehand.

Advantageously, the method of the invention further comprises a screening and shredding step, preferably implemented before the heating step.

This method may also comprise a step of coagulating-flocculating the aqueous fraction from the fractioned fatty wastes and leading to pre-purified water and hydrated slurries.

Nevertheless, a coagulation step may be carried out as well before the fractioning.

It may also be judicious that this method comprises a phase separation step, carried out on the hydrated slurries, this phase separation step consisting in separating, at least partially, the solid and liquid phases of these slurries.

The invention also relates to an equipment for the processing of fatty waste substantially composed of a fatty fraction, an aqueous fraction, and a residual fraction, this equipment comprising at least a boiler, a waste collecting station, a fractioning station, a loop including a constant working volume duct for flowing waste between the collecting station and the fractioning station, and at least a heat exchanger for heating waste, this equipment being characterized in that each heat exchanger is mounted on said duct.

This equipment comprises at least one first-type exchanger, each first-type exchanger receiving water heated by the boiler, as heat transfer fluid.

Preferably, this equipment further comprises at least one second-type exchanger, each second-type exchanger receiving, as heat transfer fluid, the aqueous fraction originating from fatty waste fractioned beforehand.

This equipment may also be provided with a preprocessing unit disposed upstream of the collecting station and comprising at least fatty waste screening means.

This equipment may further comprise a preprocessing unit, which may be the same as above, disposed upstream of each exchanger and comprising at least fatty waste shredding means as well as fatty waste filtration means.

The equipment of the invention may also comprise an aqueous fraction post-processing unit for the processing of the aqueous fraction originating from preliminarily fractioned fatty waste, this unit comprising at least dynamic separation means.

Preferably, the post-processing unit further comprises a coagulation-flocculation tank disposed upstream of the dynamic separation means.

Insofar as the fatty fraction originating from the processing of fatty waste might be subjected to a valorization operation more advantageous than the mere production of heat through combustion, the boiler is preferably designed so as to be able to burn at least a fuel other than this fatty fraction.

Other features and advantages of the invention will become more apparent upon reading the following description thereof which is given by way of a non limitative example, with reference to the unique accompanying drawing which is a global schematic view of an equipment in accordance with the invention.

As previously cited, the invention relates to an equipment for the processing of fatty waste 1 substantially composed of a fatty fraction, an aqueous fraction, and a residual fraction, as well as to a method carried out in this equipment.

This equipment comprises at least, in a manner known per se in the previously cited patent FR 2 720 014, a boiler 2, a station 3 for collecting waste 1, a fractioning station 4, a loop including a duct 5, and one or more heat exchangers such as exchangers 61 to 63.

The collecting station 3 comprises for example a storage tank 30 receiving waste 1 to be processed and preliminarily screened, and possibly, coagulation agents, a pump 31 immersed within tank 30 and capable of forcibly flowing waste 1 inside duct 5 such that its entire internal space is occupied therewith, and one or more mixing devices 32.

The fractioning station 4 is for example substantially composed of a three-phase centrifugal decanter, making it possible to separate fatty waste into a fatty organic phase 11, a liquid phase 12, and a solid phase 13.

Boiler 2 produces the thermal energy required for heating the fatty waste at least until fatty fraction 11 gets melted, this thermal energy being transferred to waste by means of heat exchangers 61 to 63.

According to the invention, each of the heat exchangers is mounted on duct 5, thus, the waste to be processed being solely heated while flowing into this duct.

The illustrated equipment includes three exchangers, 61, 62 and 63, through which duct 5 transporting waste 1 passes in this order.

Exchanger 63 receives, as heat transfer fluid, water heated by boiler 2, whereas each of exchangers 61 and 62 receives, as heat transfer fluid, the aqueous fraction 12 originating from fatty waste fractioned beforehand.

Waste 1 typically pass from a temperature of about 20° C. to a temperature of about 40° C. while traversing exchanger 61, exit from exchanger 62 at a temperature of about 60° C., leave exchanger 63 at about 85° C., and reach the fractioning station 4 at this same temperature.

The aqueous fraction 12 from fractioning station 4 is conveyed through a duct 50 towards exchanger 62 that it reaches at a temperature of about 85° C., then leaves exchanger at a temperature of about 60° C., and exchanger 61 at a temperature of about 35° C.

As shown by the drawing, the equipment advantageously comprises a pre-processing unit 7 disposed upstream of the fractioning station, and preferably upstream of exchangers 61 to 63, in the same flow direction than that of waste.

The main function of this pre-processing unit consists in calibrating waste particularly to avoid any fouling of the fractioning station 4 and duct 5.

To this end, the pre-processing unit 7 typically comprises a self-declogging screening filter 71 as well as a fatty waste shredding machine 72, these filter and machine being for example arranged upstream of the collecting station tank 30.

Preferably, the equipment of the invention also comprises a post-processing unit 8 for processing the aqueous fraction 12 originating from fatty waste fractioned beforehand.

This unit performs, for example, two successive processing stages, resulting in the purification of the aqueous fraction 12 and its disposal either towards the natural environment, or towards the sewerage system.

To this end, the post-processing unit 8 advantageously comprises a coagulation-flocculation tank 81, and dynamic separation means 82, arranged downstream of the tank and making it possible to separate the liquid phase 120 and the solid phase 121 initially contained in the aqueous fraction 12 which has been subjected to the coagulation-flocculation operation.

More precisely, the first step of the post-processing, carried out within tank 81, consists in physico-chemically eliminating the pollution of the aqueous fraction 12 through the introduction of products P ensuring the coagulation-flocculation of the particles contained within this aqueous fraction 12.

With this first step, hydrated slurries and pre-purified water are obtained, the latter being subjected to a complementary biological purification processing in order to reduce the dissolved organic load, before the disposal of such water.

With the second step of the post-processing, carried out on the hydrated slurries, for example by means of a centrifugal decanter 82, dehydrated biological and liquid slurries are obtained which are evacuated towards a suitable outlet, and also dehydration water is obtained which is subjected to the same complementary purification processing than the pre-purified water.

The fatty fraction 11 may possibly be burn within boiler 2, but may also be subjected to an external valorization process.

In this case, it should be judicious that boiler 2 intended to the heating of waste, be designed to burn at least a fuel other than the fatty fraction 11, for example, gas or fuel oil.

1. A method for processing fatty waste substantially composed of a fatty fraction, an aqueous fraction, and a residual fraction, the this method comprising at least heating, flowing and fractioning steps of respectively heating said fatty waste at least until the melting of the fatty fraction, of flowing said fatty waste from a collecting station to a fractioning station into a loop including a constant working volume duct, and of separating the fractions of the fatty waste, characterized in that the heating step is carried out by heating said fatty waste solely while flowing it into said constant working volume duct.

2. The processing method according to claim 1, characterized in that the heating step is partially carried out by reheating fatty waste to be processed by means of the aqueous fraction originating from fatty waste fractioned beforehand.

3. The processing method according to claim 1, characterized in that it further comprises a screening and shredding step carried out before the heating step.

4. The processing method according to claim 1, characterized in that it further comprises a coagulation-flocculation step of the aqueous fraction originating from fractioned fatty waste, through which pre-purified water and hydrated slurries are obtained.

5. The processing method according to claim 4, characterized in that it further comprises a phase separation step, carried out on the hydrated slurries, the phase separation step including at least partially separating liquid and solid phases of the hydrated slurries.

6. A system for the processing fatty waste substantially composed of a fatty fraction, an aqueous fraction, and a residual fraction, the system comprising at least a boiler, a waste collecting station, a fractioning station, a loop including a constant working volume duct for flowing the fatty waste between the collecting station and the fractioning station, and at least a heat exchanger for heating the fatty waste, characterized in that the at least one heat exchanger is mounted on said constant working volume duct.

7. The system according to claim 6, characterized in that at least one heat exchanger receives, as heat transfer fluid, water heated by the boiler.

8. The system according to claim 6, characterized in that at least one heat exchanger receives, as heat transfer fluid, the aqueous fraction originating from the fatty waste fractioned beforehand.

9. The system according to claim 6, characterized in that it further comprises a preprocessing unit disposed upstream of each heat exchanger and at least a fatty waste screening and shredding means, a fatty waste filtration means, and a fatty waste coagulation means.

10. The system according to claim 6, characterized in that it further comprises a unit for post-processing the aqueous fraction originating from fatty waste fractioned beforehand, the unit comprising at least a dynamic separation means.

11. The system according to claim 10, characterized in that the post-processing unit further includes a coagulation-flocculation tank, arranged upstream of the dynamic separation means.

12. The system according to claim 6, characterized in that the boiler is capable of burning at least a fuel other than the fatty fraction originating from the processed fatty waste.

13. The processing method according to claim 2, characterized in that it further comprises a screening and shredding step carried out before the heating step.

14. The processing method according to claim 2, characterized in that it further comprises a coagulation-flocculation step of the aqueous fraction originating from fractioned fatty waste, through which pre-purified water and hydrated slurries are obtained.

15. The processing method according to claim 14, characterized in that it further comprises a phase separation step, carried out on the hydrated slurries, the phase separation step including at least partially separating liquid and solid phases of the hydrated slurries.

16. The processing method according to claim 3, characterized in that it further comprises a coagulation-flocculation step of the aqueous fraction originating from fractioned fatty waste, through which pre-purified water and hydrated slurries are obtained.

17. The processing method according to claim 16, characterized in that it further comprises a phase separation step, carried out on the hydrated slurries, the phase separation step including at least partially separating liquid and solid phases of the hydrated slurries.

18. The processing method according to claim 14, characterized in that it further comprises a coagulation-flocculation step of the aqueous fraction originating from fractioned fatty waste, through which pre-purified water and hydrated slurries are obtained.

19. The processing method according to claim 16, characterized in that it further comprises a phase separation step, carried out on the hydrated slurries, the phase separation step including at least partially separating liquid and solid phases of the hydrated slurries.

20. The system according to claim 19, characterized in that at least one heat exchanger receives, as heat transfer fluid, the aqueous fraction originating from the fatty waste fractioned beforehand.

21. The system according to claim 7, characterized in that it further comprises a preprocessing unit disposed upstream of each heat exchanger and at least a fatty waste screening and shredding means, a fatty waste filtration means, and a fatty waste coagulation means.

22. The system according to claim 8, characterized in that it further comprises a preprocessing unit disposed upstream of each heat exchanger and at least a fatty waste screening and shredding means, a fatty waste filtration means, and a fatty waste coagulation means.

23. The system according to claim 7, characterized in that it further comprises a unit for post-processing the aqueous fraction originating from fatty waste fractioned beforehand, the unit comprising at least a dynamic separation means.

24. The system according to claim 23, characterized in that the post-processing unit further includes a coagulation-flocculation tank arranged upstream of the dynamic separation means.

25. The system according to claim 8, characterized in that it further comprises a unit for post-processing the aqueous fraction originating from fatty waste fractioned beforehand, the unit comprising at least a dynamic separation means.

26. The system according to claim 25, characterized in that the post-processing unit further includes a coagulation-flocculation tank arranged upstream of the dynamic separation means.

27. The system according to claim 9, characterized in that it further comprises a unit for post-processing the aqueous fraction originating from fatty waste fractioned beforehand, the unit comprising at least a dynamic separation means.

28. The system according to claim 27, characterized in that the post-processing unit further includes a coagulation-flocculation tank arranged upstream of the dynamic separation means.

29. The system according to claim 7, characterized in that the boiler is capable of burning at least a fuel other than the fatty fraction originating from the processed fatty waste.

30. The system according to claim 8, characterized in that the boiler is capable of burning at least a fuel other than the fatty fraction originating from the processed fatty waste.

31. The system according to claim 9, characterized in that the boiler is capable of burning at least a fuel other than the fatty fraction originating from the processed fatty waste.

32. The system according to claim 10, characterized in that the boiler is capable of burning at least a fuel other than the fatty fraction originating from the processed fatty waste.

33. The system according to claim 11, characterized in that the boiler is capable of burning at least a fuel other than the fatty fraction originating from the processed fatty waste.
